(19) United States
(12) Patent Application Publication
(10) Pub. No.: US 2007/0051027 A1
(43) Pub. Date: Mar. 8, 2007

(54) Rotatable bore-members

(76) Inventor: Leif Tod Stordal, Minneapolis, MN (US)

Correspondence Address: Leif Tod Stordnl, 4305 Lake Washington Blvd NE #2307, Kirkland, WA, 98033, US

(21) Appl. No.: 11/219,130

(22) Filed: Sep. 3, 2005

(51) Int. Cl. F41A 29/00; B08B 1/00

(52) U.S. Cl. 42/95; 15/104.165

(57) ABSTRACT

The invention provides rotatable adapters that can be detachably connected to a cleaning rod which allow a firearm cleaning-member to be detachably connected to the rotatable adapter such that the cleaning-member can rotate relative to the rod portion of the cleaning rod. The invention also provides rotatable rods which allow a cleaning-member that is detachably connected to the rotatable rod to rotate relative to the rod portion of the cleaning rod. The invention also provides rotatable bore-members that can be detachably connected to a cleaning rod which allow a cleaning-member to rotate relative to the rod portion of the cleaning rod.

### CROSS-REFERENCE TO RELATED APPLICATIONS

Not applicable

### STATEMENT OF FEDERALLY FUNDED RESEARCH

Not applicable

### REFERENCE TO SEQUENCE LISTING

Not applicable

### BACKGROUND OF THE INVENTION

Discharging a firearm causes a projectile to travel through the barrel of the firearm until the projectile exits from the muzzel of the barrel. This discharge causes residue to build up on the interior of the barrel that is due to material shed from the projectile and from residue resulting from ignition of propellant used to propel the projectile through the barrel. Residence of residue in the barrel of a firearm can cause a decrease in the accuracy and reliability of the firearm as well as promoting corrosion of the barrel. Accordingly, it is desirable to remove the residue from the interior of a firearm barrel.

Removal of residue from the interior of a firearm barrel is often times complicated by the presence of grooves within the interior of the firearm barrel that are referred to as rifling. These grooves are cut into the interior of the firearm barrel in a spiral such that a projectile will turn within the firearm barrel as the projectile travels through the firearm barrel. Residue will often become impacted into the grooves of the rifling making it difficult to remove the residue during the cleaning process. Accordingly, what is needed is a device that can be used to lessen the burden of removing residue from rifling grooves during firearm cleaning.

1. Field of the Invention

The invention relates to rotatable adapters, rotatable rods and rotatable bore-members that can be used during the process of cleaning the interior of a firearm barrel.

2. Description of the Related Art

Cleaning rods and jigs that can be used to clean a firearm barrel currently exist. A cleaning rod includes a rod portion. The rod portion has a proximal end and a distal end. A handle is often times rotatably attached to the proximal end of the rod portion such that the handle can freely rotate relative to the rod portion of the cleaning rod. The distal end of the rod portion is often times threaded so that it is able to be coupled to a jig or an adapter. Numerous jigs exist that are exemplified by loops, jags, brushes and swabs. Numerous adapters also exist and are exemplified by adapters that convert the thread of the distal end of the rod portion to another thread that is compatible with a variety of jigs. Current adapters and jigs attach to the distal end of the rod portion in a non-rotatable manner. Accordingly, these adapters and jigs are unable to rotate relative to the rod portion of a cleaning rod to which they are attached. This inability to rotate can cause the jig to unscrew from the distal end of the rod portion of a cleaning rod within the jig is pushed through the firearm barrel due to the spiral rifling within the interior of the firearm barrel. Alternatively, the jig is unable to adequately clean the spaces between the grooves of the rifling within the interior of the firearm barrel due to its inability to rotate freely within the firearm barrel.

### BRIEF SUMMARY OF THE INVENTION

The invention provides rotatable adapters that can be connected to a cleaning rod which allow a cleaning-member to be connected to the rotatable adapter such that the cleaning-member can rotate relative to the rod portion of the cleaning rod. The invention also provides rotatable rods which allow a cleaning-member that is connected to the rotatable rod to rotate relative to the rod portion of the cleaning rod. The invention also provides rotatable bore-members that can be connected to a cleaning rod which allow a cleaning-member to rotate relative to the rod portion of the cleaning rod.

In some embodiments, the invention provides a rotatable adapter for use in cleaning a firearm barrel includes a first member having a rod coupling for detachable connection to a firearm-cleaning rod; and a second member having a cleaning-member coupling for detachable connection to a firearm-cleaning member; where the first member and the second member are rotatably attached to one another and configured to fit within the barrel of a firearm.

In some embodiments, the invention provides a rotatable rod for cleaning a firearm barrel that includes a first member; a second member that includes a cleaning-member coupling for detachable connection to a firearm-cleaning member; and a rod having a proximal end and a distal end, where the first member is attached to the distal end of the rod, the second member is rotatably attached to the first member, the rotatable rod is configured to fit within the barrel of a firearm, and the rod does not include a continuous lumen between the proximal end and the first member.

In some embodiments, the invention provides a rotatable bore-member for cleaning a firearm barrel that includes a first member having a rod coupling that is configured for detachable connection to a firearm-cleaning rod; and a second member that is a firearm-cleaning member for cleaning the barrel of a firearm, where the first member and the second member are rotatably attached to each other and configured to fit within the barrel of a firearm.

In some embodiments, the invention provides a kit that includes a cleaning rod, and a rotatable adapter.

In some embodiments, the invention provides a kit that includes a rotatable rod and a firearm-cleaning member.

In some embodiments, the invention provides a rotatable adapter for cleaning a firearm barrel that includes a first member having a circular cross-section transverse to an axis of rotation, a substantially smooth exterior, and a rod coupling that is configured to detachably connect to a firearm-cleaning rod; a second member having a circular cross-section transverse to an axis of rotation, a substantially smooth exterior, and a cleaning-member coupling that is configured to detachably connect to a firearm-cleaning member, where the first member and the second member are rotatably attached to one another and configured to fit within the barrel of a firearm.

In some embodiments, the invention provides a rotatable rod for cleaning a firearm barrel that includes a first member; a second member having a circular cross-section transverse to an axis of rotation, a substantially smooth exterior, and a cleaning-member coupling that is configured to detachably connect to a firearm-cleaning member; and a rod having a proximal end and a distal end, where the first member is attached to the distal end of the rod, the second member is rotatably attached to the first member, the rotatable rod is configured to fit within the barrel of a firearm, and the rod does not include a continuous lumen in connection with the first member.

In some embodiments, the invention provides a rotatable bore-member for cleaning a firearm barrel that includes a first member having a circular cross-section transverse to an axis of rotation, a substantially smooth exterior, and a rod coupling that is configured to detachably connect to a firearm-cleaning rod; a second member that is a firearm-cleaning member adapted to clean the barrel of a firearm, where the first member and the second member are rotatably attached to one another and configured to fit within the barrel of a firearm.

In some embodiments, the invention provides a rotatable adapter for cleaning a firearm barrel that includes a cleaning-rod attachment mechanism configured for detachable connection of a firearm-cleaning member to a cleaning rod; and a means for allowing rotation of the firearm-cleaning member relative to the firearm-cleaning rod.

In some embodiments, the invention provides a rotatable rod for cleaning a firearm barrel that includes a rod having a proximal end and a distal end; and a means for allowing free rotation of a firearm-cleaning member relative to the rod that is attached to the distal end of the rod, where the rotatable rod is configured to fit within the barrel of a firearm, and the rod does not include a continuous lumen in connection with the means for allowing rotation.

In some embodiments, the invention provides a rotatable bore-member for cleaning a firearm barrel that includes a cleaning-rod attachment mechanism configured for detachable connection of a firearm-cleaning member to a cleaning rod; and a means for allowing rotation of the firearm-cleaning member relative to the firearm-cleaning rod, where-the means for allowing rotation includes the firearm-cleaning member.

### BRIEF DESCRIPTION OF THE DRAWINGS

FIG. 1A is a drawing of a cleaning rod, a rotatable adapter and a cleaning-member.

FIG. 1B is a drawing of rotatable rod and a cleaning-member.

FIG. 1C is a drawing of a cleaning rod and a rotatable bore-member.

FIG. 2 is a drawing showing a rotatable adapter.

FIG. 3 is a drawing showing a rotatable adapter.

FIG. 4 is a drawing showing a rotatable adapter.

FIG. 5 is a drawing showing a rotatable adapter.

FIG. 6 is a drawing showing a rotatable adapter.

FIG. 7 is a drawing showing a rotatable adapter.

FIG. 8 is a drawing showing a rotatable adapter.

FIG. 9 is a drawing showing a rotatable adapter.

FIG. 10 is a drawing showing a rotatable adapter.

FIG. 11A is a drawing showing a method to fabricate a rotatable adapter.

FIG. 11B is a drawing showing a method to fabricate a rotatable adapter.

FIG. 12A is a drawing showing a method to fabricate a rotatable adapter.

FIG. 12A is a drawing showing a method to fabricate a rotatable adapter.

FIG. 13 is a drawing showing a rotatable rod.

FIG. 14 is a drawing showing a rotatable rod.

FIG. 15 is a drawing showing a rotatable rod.

FIG. 16 is a drawing showing a rotatable rod.

FIG. 17 is a drawing showing a rotatable rod.

FIG. 18 is a drawing showing a rotatable rod.

FIG. 19 is a drawing showing a rotatable rod.

FIG. 20A is a drawing showing a method to fabricate a rotatable rod.

FIG. 20B is a drawing showing a method to fabricate a rotatable rod.

FIG. 21 is a drawing showing a rotatable bore-member having a loop.

FIG. 22 is a drawing showing a rotatable bore-member having a brush.

FIG. 23 is a drawing showing a rotatable bore-member having a swab.

FIG. 24 is a drawing showing a rotatable bore-member having a loop.

FIG. 25 is a drawing showing a rotatable bore-member having a brush.

FIG. 26 is a drawing showing a rotatable bore-member having a swab.

FIG. 27 is a drawing showing a rotatable bore-member having a loop.

FIG. 28 is a drawing showing a rotatable bore-member having a brush.

FIG. 29 is a drawing showing a rotatable bore-member having a swab.

### DETAILED DESCRIPTION

The present invention provides rotatable adapters, rotatable rods, and rotatable bore-members that can be used to clean the interior of tube. The rotatable adapters, rotatable rods, and rotatable bore-members are suitable for cleaning the interior of a tube that contains grooves on the interior. In some examples, the grooved tube is a rifled firearm barrel. In such a rifled barrel, grooves are cut into the interior of the firearm barrel that twist in accordance with the length of the barrel.

During the process of cleaning a firearm barrel a cleaning-member is attached to a cleaning rod. The cleaning-member is then pushed through the barrel of a firearm through use of the cleaning rod to remove residue from the interior of the firearm barrel. As the cleaning-member travels through the barrel of a rifled barrel, the cleaning-member will engage the grooves of the rifling. If the cleaning-member is not free to rotate, residue impacted within the grooves of the rifling will not be removed by the cleaning-member as the cleaning-member will not fully engage the grooves. Currently, cleaning rods having a rotatable handle are used to allow the cleaning-member and cleaning rod to freely rotate with the twist of the grooves of the rifling to allow removal of residue impacted within the grooves of the rifling. A disadvantage of the current system is that the cleaning rod must be free to rotate. Accordingly, if the cleaning rod is grasped in a manner that disallows the cleaning rod to rotate, the cleaning-member will also be disallowed from rotatable and residue impacted within the grooves of the rifling will not be removed.

The present invention provides rotatable adapters, rotatable rods, and rotatable bore-members that are free to rotate within a firearm barrel even if the rod portion of the cleaning rod is not free to rotate. Accordingly, an advantage of the present invention is that it provides for improved removal of residue impacted into the grooves of a rifled firearm barrel. This improvement is applicable to sporting firearms as well as large caliber barrels found in artillery pieces and naval guns. In such applications, the rod portion of a cleaning rod used to clean such barrels can be attached to a device that pushes the rod through the barrel without having to allow the rod portion to rotate.

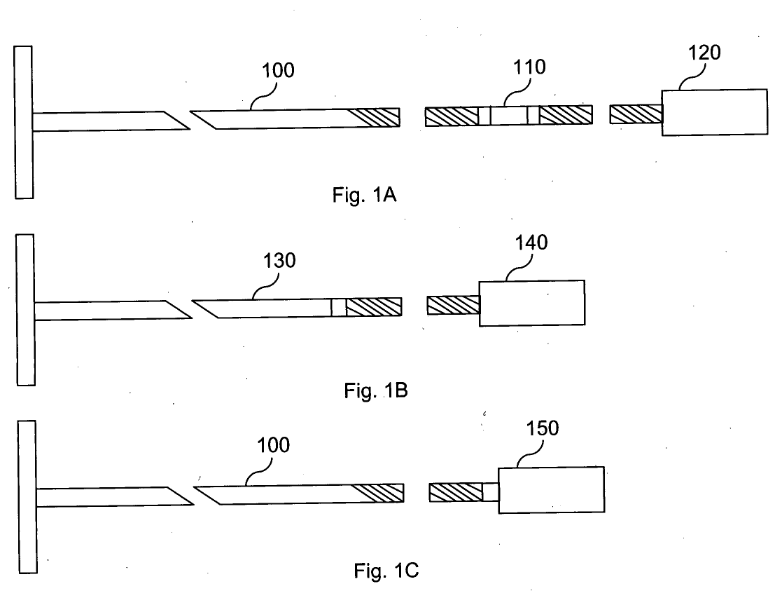

FIG. 1 shows multiple embodiments of the invention. FIG. 1A shows a firearm-cleaning rod (100), a rotatable adapter (110) and a firearm-cleaning member (120). FIG. 1B shows a rotatable rod (130) and a firearm-cleaning member (140). FIG. 1C shows a cleaning rod (100) and a rotatable bore-member (150).

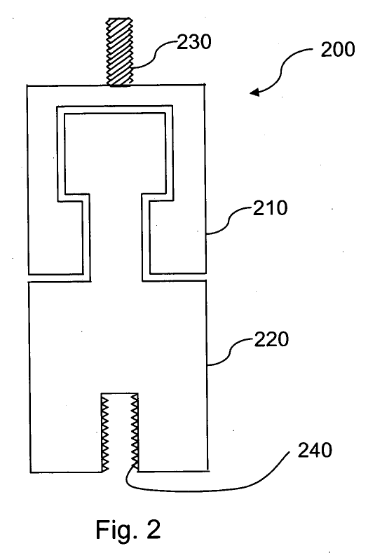

FIG. 2 shows one embodiment of a rotatable adapter (200) of the invention. Here a rotatable adapter (200) is shown having a first member (210) and a second member (220) that are rotatably attached. The rotatable adapter also shows a threaded rod coupling (230) and a threaded cleaning-member coupling (240).

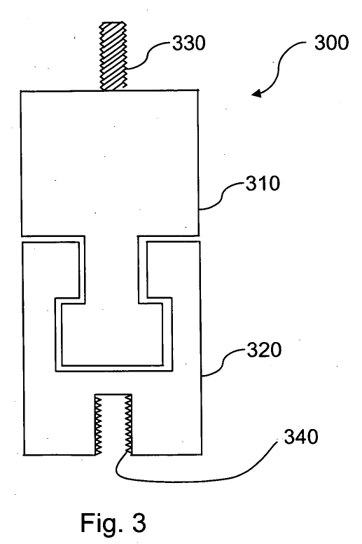

FIG. 3 shows another embodiment of a rotatable adapter (300) of the invention. Here a rotatable adapter (300) is shown having a first member (310) and a second member (320) that are rotatably attached. The rotatable adapter also shows a threaded rod coupling (330) and a threaded cleaning-member coupling (340).

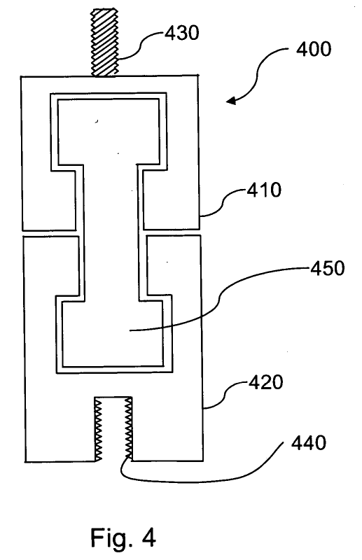

FIG. 4 shows another embodiment of a rotatable adapter (400) of the invention. Here a rotatable adapter (400) is shown having a first member (410), a second member (420), and a third member (450) that are rotatably attached. The rotatable adapter also shows a threaded rod coupling (430) and a threaded cleaning-member coupling (440).

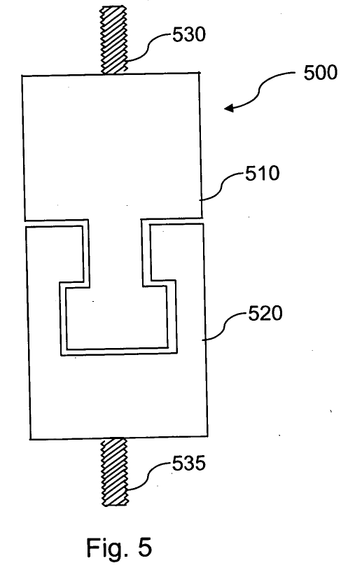

FIG. 5 shows another embodiment of a rotatable adapter (500) of the invention. Here a rotatable adapter (500) is shown having a first member (510) and a second member (520) that are rotatably attached. The rotatable adapter also shows a first threaded rod coupling (530) and a second threaded cleaning-member coupling (535).

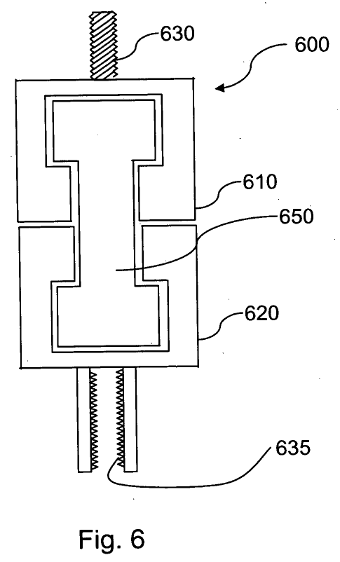

FIG. 6 shows another embodiment of a rotatable adapter (600) of the invention. Here a rotatable adapter (600) is shown having a first member (610), a second member (620), and a third member (650) that are rotatably attached. The rotatable adapter also shows a first threaded rod coupling (630) and a second threaded cleaning-member coupling (635).

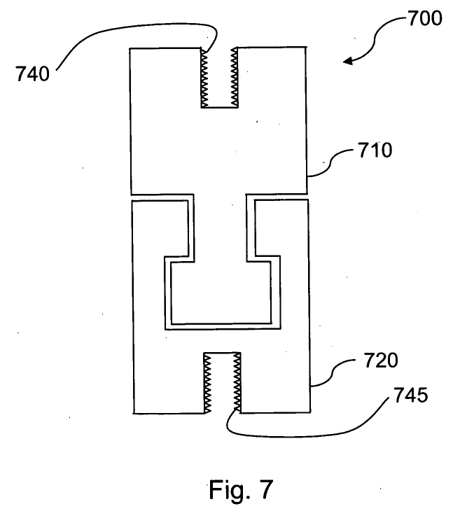

FIG. 7 shows another embodiment of a rotatable adapter (700) of the invention. Here a rotatable adapter (700) is shown having a first member (710) and a second member (720) that are rotatably attached. The rotatable adapter also shows a first threaded rod coupling (740) and a second threaded cleaning-member coupling (745).

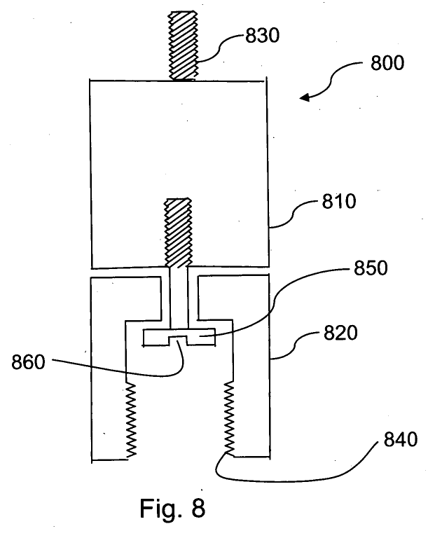

FIG. 8 shows another embodiment of a rotatable adapter (800) of the invention. Here a rotatable adapter (800) is shown having a first member (810) and a second member (820) that are rotatably attached. The rotatable adapter also shows a third member (850) that passes through the second member (820) and attaches to the first member (810). The third member (850) is shown as including a notch (860). Also shown is a threaded rod coupling (830) and a threaded cleaning-member coupling (840).

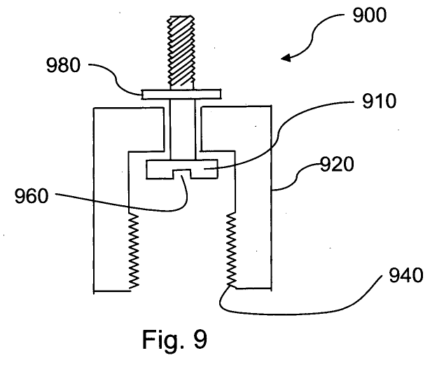

FIG. 9 shows another embodiment of a rotatable adapter (900) of the invention. Here a rotatable adapter (900) is shown having a first member (910) and a second member (920) that are rotatably attached. The first member (910) is shown as including a notch (960). A locking washer (980) is shown attached to the first member (910). Also shown is a threaded cleaning-member coupling (940).

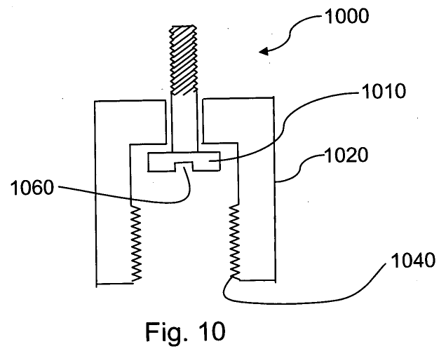

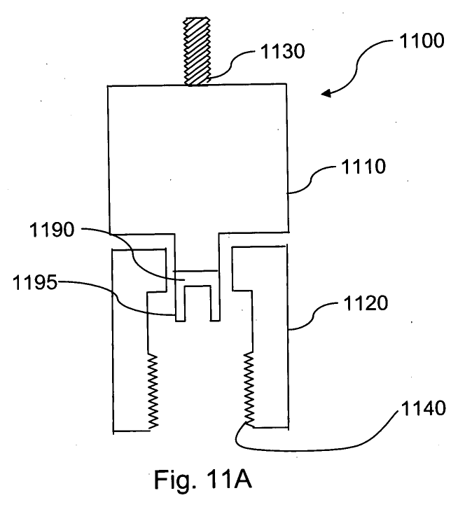

FIG. 10 shows another embodiment of a rotatable adapter (1000) of the invention. Here a rotatable adapter (1000) is shown having a first member (1010) and a second member (1020) that are rotatably attached. The first member (1010) is shown as including a notch (1060). Also shown is a threaded cleaning-member coupling (1040).

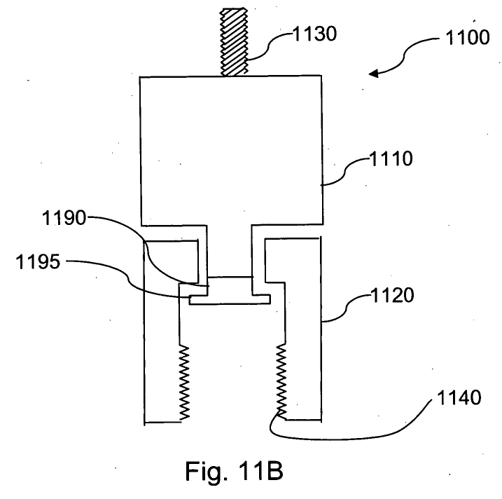

FIGS. 11A and 11B show a method to fabricate a rotatable adapter (1100) of the invention. FIG. 11A shows a rotatable adapter (1100) having a first member (1110) and a second member (1120). An expanding member (1190) having bendable flanges (1195) is shown protruding from the first member (1110) and extending through the second member (1120). The first member (1110) has a threaded rod coupling (1130) and the second member (1120) has a threaded cleaning-member coupling (1140). FIG. 11B shows the rotatable adapter of FIG. 11A after the bendable flanges (1195) of the expanding member (1190) were bent to secure the first member (1110) to the second member (1120).

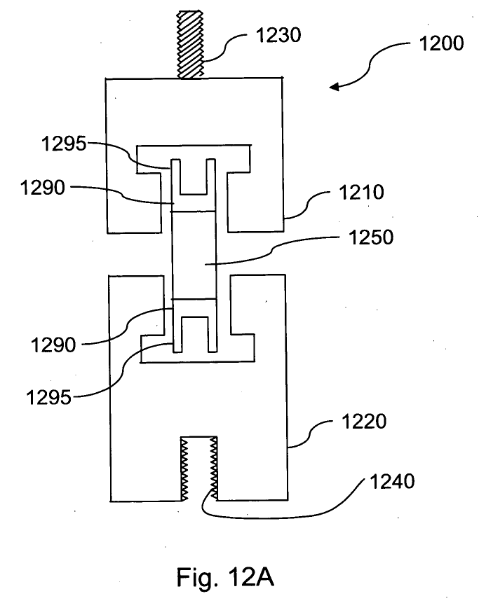

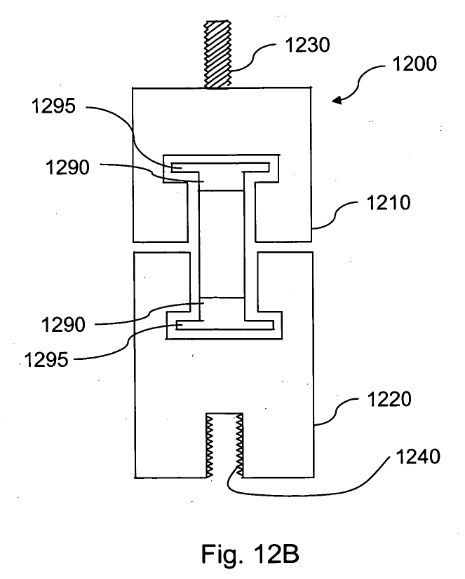

FIGS. 12A and 12B show a method to fabricate a rotatable adapter (1200) of the invention. FIG. 12A shows a rotatable adapter (1200) having a first member (1210) and a second member (1220). A third member (1250) having two expanding members (1290) having bendable flanges (1295) is shown positioned between the first (1210) and second (1220) members. The first member (1210) has a threaded rod coupling (1230) and the second member (1220) has a threaded cleaning-member coupling (1240). FIG. 12B shows the rotatable adapter of FIG. 12A after the bendable flanges (1295) of the expanding members (1290) were bent to secure the first (1210) and second (1220) members to the third member (1250).

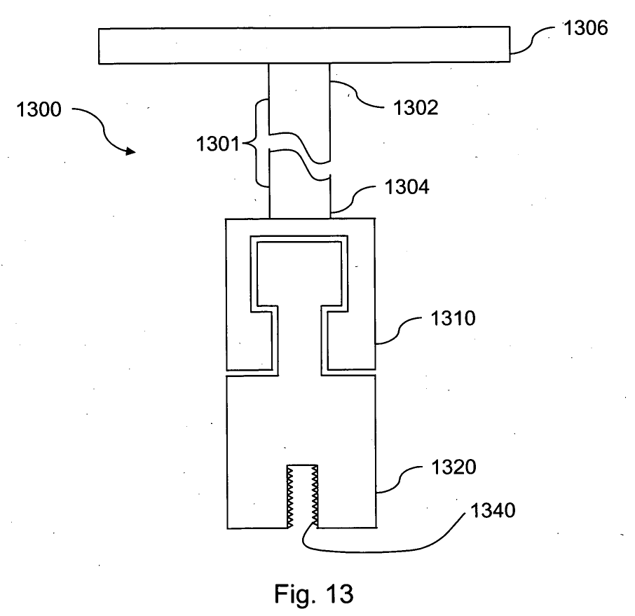

FIG. 13 shows one embodiment of a rotatable rod (1300) of the invention. Here a rod (1301) is shown having a proximal end (1302) and a distal end (1304). To the proximal end (1302) is attached a handle (1306). To the distal end (1304) is attached a first member (1310). A second member (1320) is rotatably attached to the first member (1310). Also shown is a threaded rod coupling (1340).

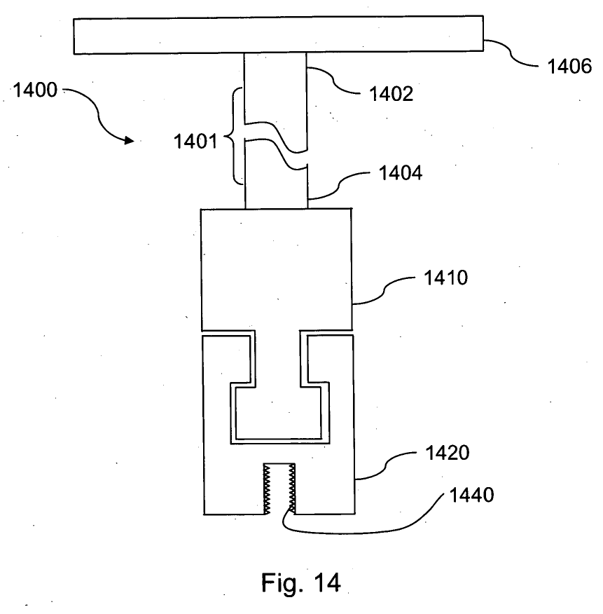

FIG. 14 shows another embodiment of a rotatable rod (1400) of the invention. Here a rod (1401) is shown having a proximal end (1402) and a distal end (1404). To the proximal end (1402) is attached a handle (1406). To the distal end (1404) is attached a first member (1410). The first member (1410) is rotatably attached to a second member (1420). Also shown is a threaded cleaning-member coupling (1440).

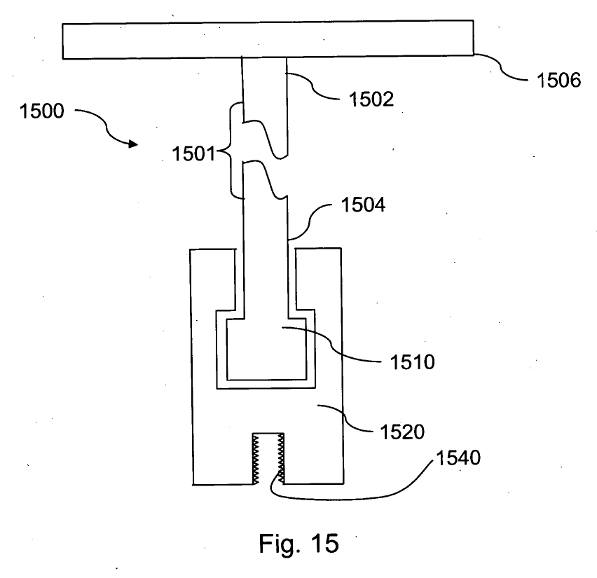

FIG. 15 shows another embodiment of a rotatable rod (1500) of the invention. Here a rod (1501) is shown having a proximal end (1502) and a distal end (1504). To the proximal end (1502) is attached a handle (1506). A first member (1510) is shown continuously attached to the distal end (1504) of the rod (1501). A second member (1520) is rotatably attached to the first member (1510). Also shown is a threaded cleaning-member coupling (1540).

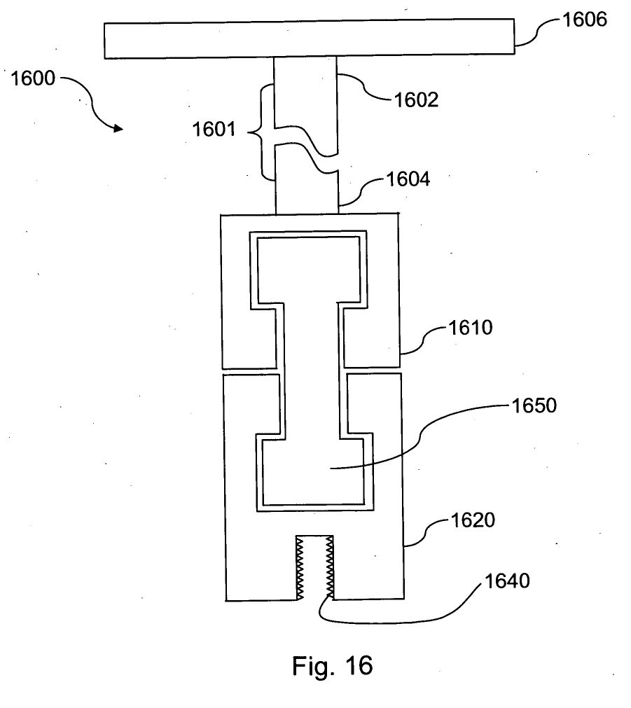

FIG. 16 shows another embodiment of a rotatable rod (1600) of the invention. Here a rod (1601) is shown having a proximal end (1602) and a distal end (1604). To the proximal end (1602) is attached a handle (1606). A first member (1610) and a second member (1620) are shown rotatably attached to a third member (1650). The first member is shown attached to the distal end (1604) of the rod (1601). Also shown is a threaded cleaning-member coupling (1640).

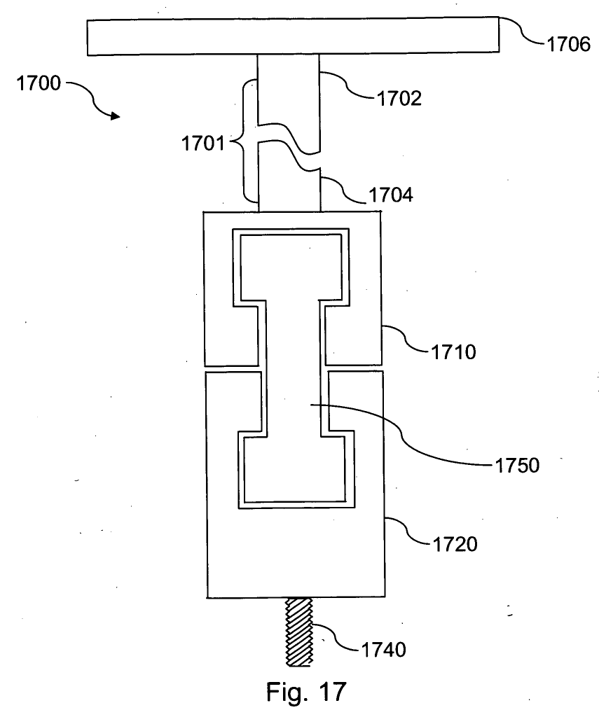

FIG. 17 shows another embodiment of a rotatable rod (1700) of the invention. Here a rod (1701) is shown having a proximal end (1702) and a distal end (1704). To the proximal end (1702) is attached a handle (1706). A first member (1710) and a second member (1720) are shown rotatably attached to a third member (1750). The first member (1710) is shown attached to the distal end (1704) of the rod (1701). Also shown is a threaded cleaning-member coupling (1740).

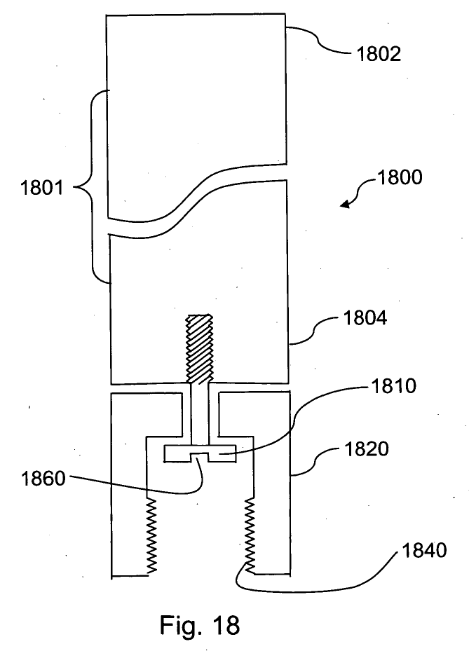

FIG. 18 shows another embodiment of a rotatable rod (1800) of the invention. Here a rod (1801) is shown having a proximal end (1802) and a distal end (1804). A first member (1810) is shown attached to the distal end (1804) of the rod (1801). The first member (1810) passes through a second member (1820) and attaches to the distal end (1804) of the rod (1801). The first member (1810) is shown as including a notch (1860). Also shown is a threaded cleaning-member coupling (1840).

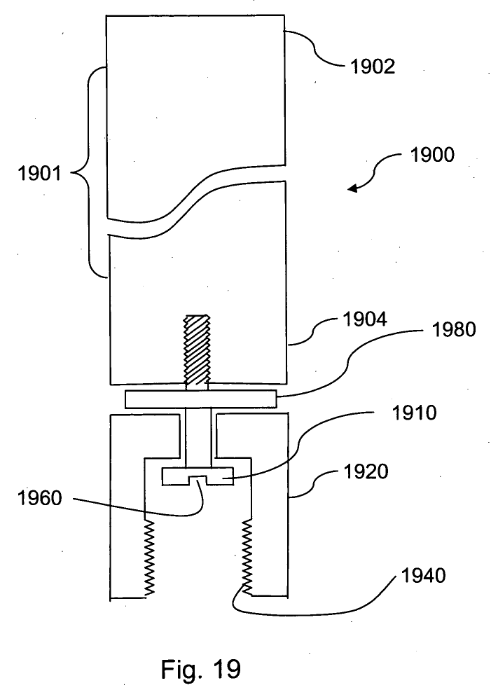

FIG. 19 shows another embodiment of a rotatable rod (1900) of the invention. Here a rod (1901) is shown having a proximal end (1902) and a distal end (1904). A first member (1910) is shown attached to the distal end (1904) of the rod (1901). The first member (1910) passes through a second member (1920) and rotatably attaches the second member (1920) to the distal end (1904) of the rod (1901). The first member (1910) is shown as including a notch (1960). A locking washer (1980) is shown attached to the first member (1910). Also shown is a threaded internal cleaning-member coupling (1940).

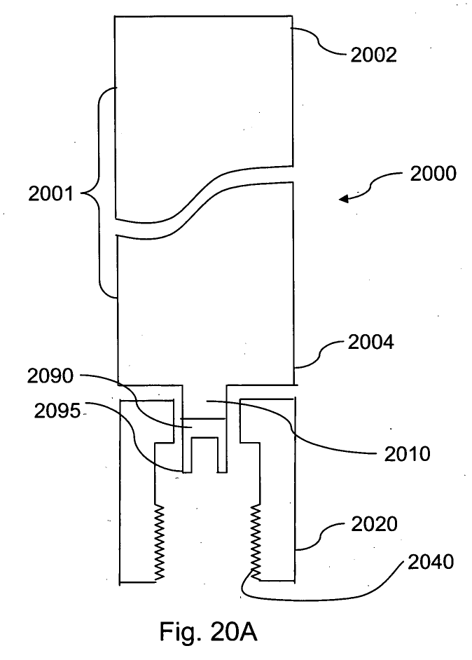

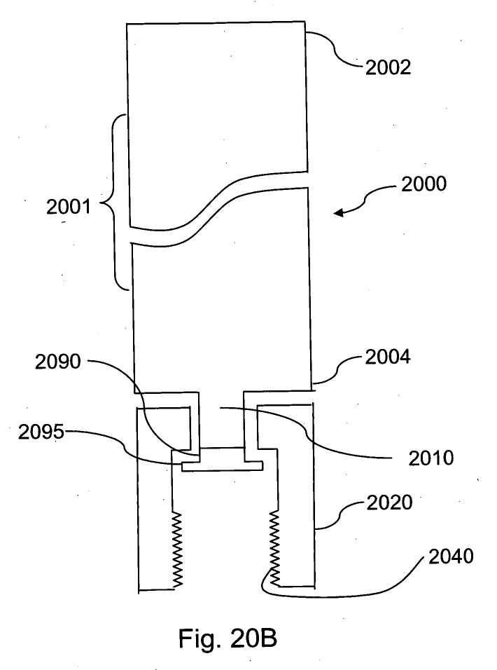

FIGS. 20A and 20B show a method to fabricate a rotatable rod (2000) of the invention. FIG. 20A shows a rod (2001) having a proximal end (2002) and a distal end (2004). An expanding member (2090) having bendable flanges (2095) is shown protruding from the distal end (2004) of the rod (2001) to form a first member (2010). The first member (2010) extends through a second member (2020). The second member (2020) has a threaded cleaning-member coupling (2040). FIG. 20B shows the rotatable rod of FIG. 20A after the bendable flanges (2095) of the expanding member (2090) were bent to secure the second member (2020) onto the distal end (2004) of the rod (2001).

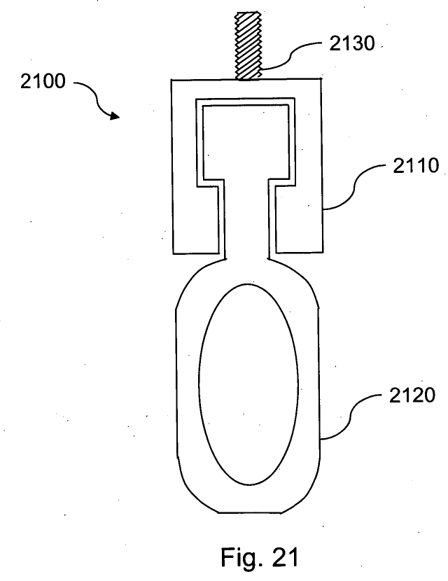

FIG. 21 shows one embodiment of a rotatable bore-member (2100) of the invention. Here a rotatable bore-member (2100) is shown having a first member (2110) and a second member (2120) that are rotatably attached. The second member (2120) includes a loop. The rotatable member also shows a threaded rod coupling (2130).

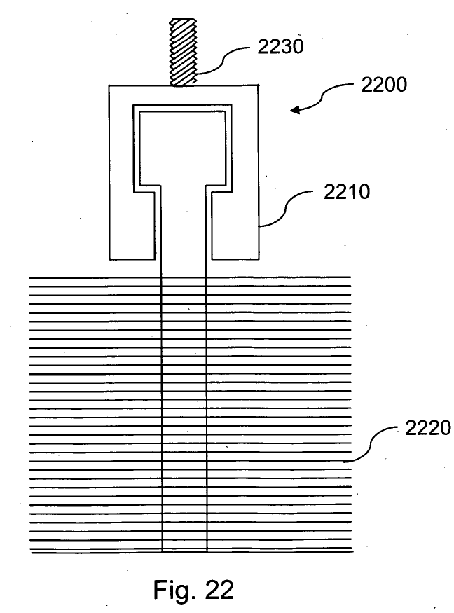

FIG. 22 shows another embodiment of a rotatable bore-member (2200) of the invention. Here a rotatable bore-member (2200) is shown having a first member (2210) and a second member (2220) that are rotatably attached. The second member (2220) includes a brush. The rotatable member also shows a threaded rod coupling (2230).

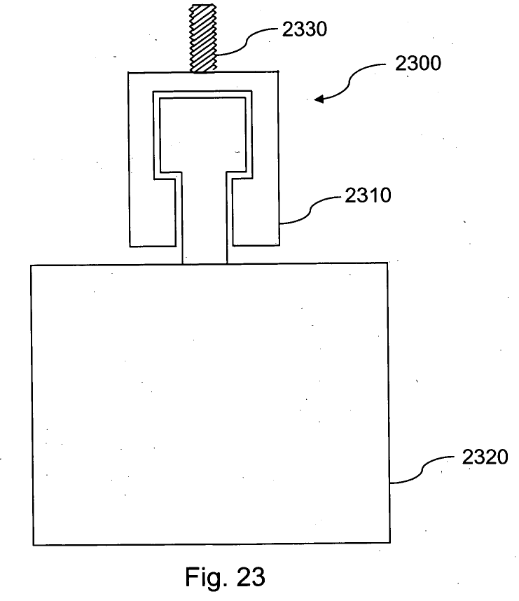

FIG. 23 shows another embodiment of a rotatable bore-member (2300) of the invention. Here a rotatable member (2300) is shown having a first member (2310) and a second member (2320) that are rotatably attached. The second member (2320) includes a swab. The rotatable bore-member also shows a threaded rod coupling (2330).

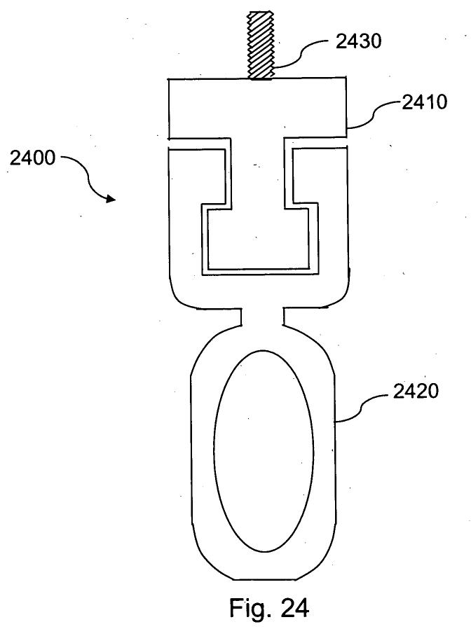

FIG. 24 shows one embodiment of a rotatable bore-member (2400) of the invention. Here a rotatable bore-member (2400) is shown having a first member (2410) and a second member (2420) that are rotatably attached. The first member (2410) includes a loop. The rotatable bore-member also shows a threaded rod coupling (2430).

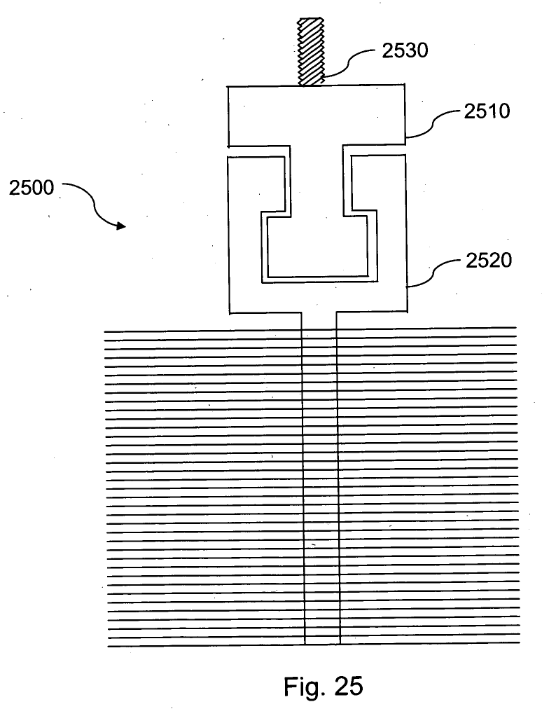

FIG. 25 shows another embodiment of a rotatable bore-member (2500) of the invention. Here a rotatable bore-member (2500) is shown having a first member (2510) and a second member (2520) that are rotatably attached. The second member (2520) includes a brush. The rotatable bore-member also shows a threaded rod coupling (2530).

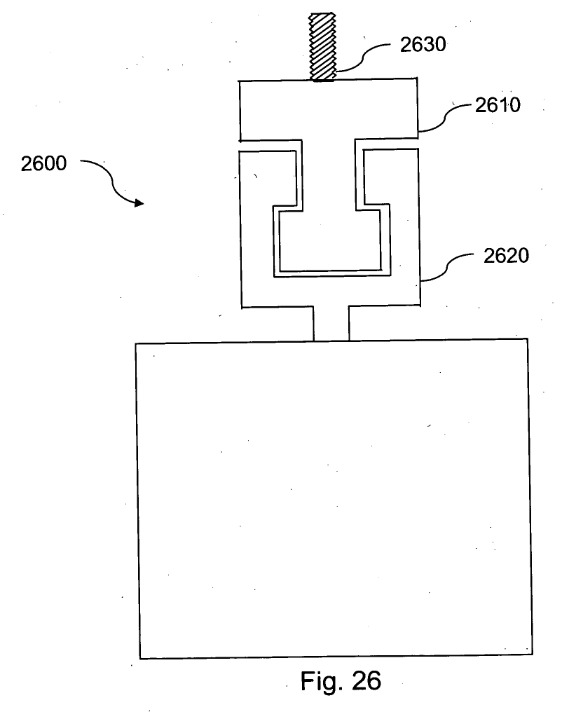

FIG. 26 shows another embodiment of a rotatable bore-member (2600) of the invention. Here a rotatable bore-member (2600) is shown having a first member (2610) and a second member (2620) that are rotatably attached. The first member (2610) includes a swab. The rotatable bore-member also shows a threaded rod coupling (2630).

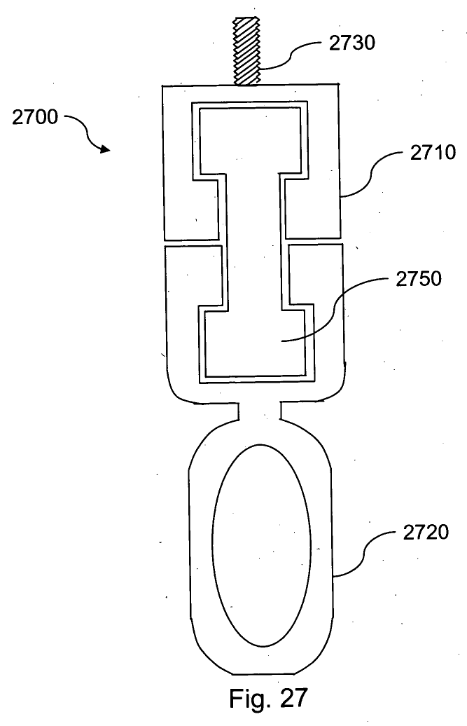

FIG. 27 shows another embodiment of a rotatable bore-member (2700) of the invention. Here a rotatable bore-member (2700) is shown having a first member (2710) and a second member (2720). The first member (2710) and the second member (2720) are rotatably attached to a third member (2750). The second member (2720) is configured as a loop. The rotatable bore-member also shows a threaded rod coupling (2730).

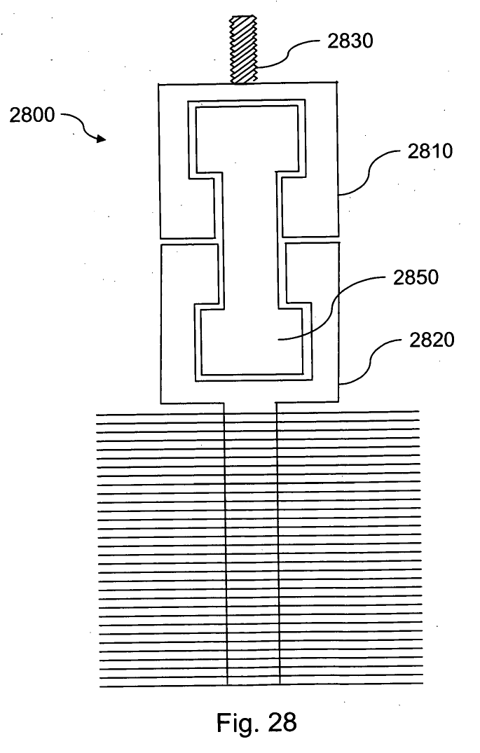

FIG. 28 shows another embodiment of a rotatable bore-member (2800) of the invention. Here a rotatable bore-member (2800) is shown having a first member (2810) and a second member (2820). The second member (2820) is shown as being configured as a brush. The first member (2810) and the second member (2820) are rotatably attached to a third member (2850). The rotatable bore-member also shows a threaded rod coupling (2830).

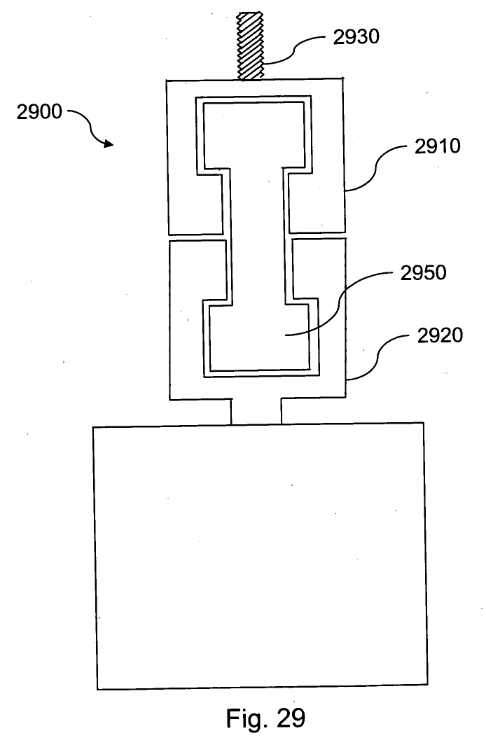

FIG. 29 shows another embodiment of a rotatable bore-member (2900) of the invention. Here a rotatable bore-member (2900) is shown having a first member (2910) and a second member (2920). The second member (2920) is show as being configured as a swab. The first member (2910) and the second member (2920) are rotatably attached to a third member (2950). The rotatable bore-member also shows a threaded rod coupling (2930).

### Rotatable Adapters

The invention provides rotatable adapters. An advantage of these adapters is that they allow a firearm-cleaning member to freely rotate with the rifling of a firearm barrel. The free rotation of the firearm-cleaning member is thought to provide for better cleaning of the barrel due to the ability of the firearm-cleaning member to conform to the spaces between the rifling of the firearm. In addition, allowing the firearm-cleaning member to freely rotate with the rifling of a firearm barrel as the firearm-cleaning member is pushed in one direction and pulled in the other direction during the firearm cleaning process, increases the safety of the cleaning process because it lessens the possibility that a firearm-cleaning member will unscrew from a firearm-cleaning rod and become lodged in the barrel of the firearm. Such an occurence could cause the barrel to become plugged and cause injury to an individual if the firearm is discharged while plugged.

The rotatable adapters of the invention can be fabricated from many types of material. Examples of such materials include, but are not limited to, plastics, metals, ceramics, and polymers. Additional examples of materials that can be used to fabricate rotatable adapters include steel, brass, bronze, aluminum, teflon, nylon, polycarbonate, and the like. Rotatable adapters can also be fabricated from combinations of materials. In addition, rotatable adapters can be fabricated with one material and then coated with one or more other materials. For example, a rotatable adapter can be fabricated from a metal or metal alloy and then coated with plastic.

Rotatable adapters can be fabricated through use of a variety of methods that are known in the art. For example, rotatable adapters can be cast using sand casting techniques or through of reusable or non-reusable molds. Rotatable adapters can be machined from bar stock. For example, a first and second member can be machined and then assembled into a rotatable adapter. The individual members of a rotatable adapter can be rotatably attached to each other through use of many methods known in the art. For example, the individual members of a rotatable adapter can be screwed together, bolted together, riveted together, attached to each other through use of expansion couplings, cast together, and the like.

The couplings included in the rotatable adapters can include rod couplings that are configured to screw into commercially available firearm-cleaning rods. The couplings included in the rotatable adapters can also be firearm cleaning-member couplings that are configured to accept many commercially available adapters and firearm-cleaning members that are commercially available. Examples of such firearm-cleaning members include firearm-cleaning rods, thread adapters, jags, swabs, brushes, loops, and the like. Accordingly, if the couplings are threaded, the threads of the rotatable adapters are complimentary to those of commercially available firearm-cleaning rods and firearm-cleaning members. The couplings can also be fabricated as expansion couplings as are known in the art.

The rotatable adapters can be configured to fit within firearm barrels of many different calibers and gauges that indicate the inside diameter of the barrel. Examples of such calibers and inner diameters (with corresponding diameter in millimeters) include 17 (4.32 mm), 22 (5.59 mm), 23 (5.84 mm), 6 mm, 24 (6.1 mm), 25 (6.35 mm), 26 (6.60 mm), 27 (6.86 mm), 7 mm, 28 (7.11 mm), 29 (7.37 mm), 30 (7.62 mm), 31 (7.87 mm), 32 (8.13 mm), 33 (8.38 mm), 34 (8.64 mm), 35 (8.89 mm), 36 (9.14 mm), 37 (9.4 mm), 38 (9.65 mm), 39 (9.91 mm), 40 (10.16 mm), 41 (10.41 mm), 42 (10.67 mm), 43 (10.92 mm), 44 (11.18 mm), 45 (11.43 mm), 46 (11.68 mm), 47 (11.94 mm), 48 (12.19 mm), 49 (12.45 mm), and 50 (12.7 mm) caliber. Examples of such gauges (with corresponding diameter in millimeters) include 28 (13.95 mm), 24 (14.68 mm), 20 (15.67 mm), 16 (16.84 mm), 14 (17.60 mm), 13 (18.06 mm), 12 (18.52 mm), 10 (19.74 mm), and 8 (21.26 mm) gauge as well as “410 guage” that corresponds to 41 caliber (10.41 mm). The rotatable adapters can also be configured to fit with larger barrels such as those found in artillery pieces and naval guns. Examples of such artillery pieces and naval guns include, but are not limited to, those having barrels with an inner diameter of 101 mm, 120 mm, 155 mm and 203 mm.

### Rotatable Rods

The invention provides rotatable rods. These rotatable rods offer the same advantages as described herein for rotatable adapters.

The rotatable rods of the invention can be fabricated from many types of material. Examples of such materials include, but are not limited to, plastics, metals, ceramics, and polymers. Additional examples of materials that can be used to fabricate rotatable rods include steel, brass, bronze, aluminum, teflon, nylon, polycarbonate, and the like. Rotatable rods can also be fabricated from combinations of materials. In addition, rotatable rods can be fabricated with one material and then coated with one or more other materials. For example, a rotatable adapter can be fabricated from a metal or metal alloy and then coated with an additional material such as plastic, teflon, rubber, paint, and the like. Rotatable rods that are coated with a soft material are useful for preserving the rifling of a barrel.

Rotating rods of the invention can be fabricated through of many techniques that are known in the art and include many of those techniques described for fabricating rotatable adapters.

The rotatable rods can be configured to fit within firearm barrels of many different calibers and gauges that indicate the inside diameter of the barrel. Examples of such calibers and inner diameters (with corresponding diameter in millimeters) include 17 (4.32 mm), 22 (5.59 mm), 23 (5.84 mm), 6 mm, 24 (6.1 mm), 25 (6.35 mm), 26 (6.60 mm), 27 (6.86 mm), 7 mm, 28 (7.11 mm), 29 (7.37 mm), 30 (7.62 mm), 31 (7.87 mm), 32 (8.13 mm), 33 (8.38 mm), 34 (8.64 mm), 35 (8.89 mm), 36 (9.14 mm), 37 (9.4 mm), 38 (9.65 mm), 39 (9.91 mm), 40 (10.16 mm), 41 (10.41 mm), 42 (10.67 mm), 43 (10.92 mm), 44 (11.18 mm), 45 (11.43 mm), 46 (11.68 mm), 47 (11.94 mm), 48 (12.19 mm), 49 (12.45 mm), and 50 (12.7 mm) caliber. Examples of such gauges (with corresponding diameter in millimeters) include 28 (13.95 mm), 24 (14.68 mm), 20 (15.67 mm), 16 (16.84 mm), 14 (17.60 mm), 13 (18.06 mm), 12 (18.52 mm), 10 (19.74 mm), and 8 (21.26 mm) gauge as well as “410 guage” that corresponds to 41 caliber (10.41 mm). The rotatable rods can also be configured to fit with larger barrels such as those found in artillery pieces and naval guns. Examples of such artillery pieces and naval guns include, but are not limited to, those having barrels with an inner diameter of 101 mm, 120 mm, 155 mm and 203 mm.

### Rotatable Bore-Members

The invention provides rotatable bore-members. These rotatable bore-members offer the same advantages as described herein for rotatable adapters.

The rotatable bore-members of the invention can be fabricated from many types of material. Examples of such materials include, but are not limited to, plastics, metals, ceramics, and polymers. Additional examples of materials that can be used to fabricate rotatable bore-members include steel, brass, bronze, aluminum, teflon, nylon, polycarbonate, composites, and the like. Rotatable bore-members can also be fabricated from combinations of materials. In addition, rotatable bore-members can be fabricated with one material and then coated with one or more other materials. For example, a rotatable bore-member can be fabricated from a metal or metal alloy and then coated with an additional material such as plastic, teflon, rubber, paint, and the like.

Rotatable bore-members can be configures with many types of firearm-cleaning members. Examples of such firearm-cleaning members include loops, brushes, jags, swabs, and the like.

Rotating bore-members of the invention can be fabricated through of many techniques that are known in the art and include many of those techniques described for fabricating rotatable adapters.

The rotatable bore-members can be configured to fit within firearm barrels of many different calibers and gauges that indicate the inside diameter of the barrel. Examples of such calibers and inner diameters (with corresponding diameter in millimeters) include 17 (4.32 mm), 22 (5.59 mm), 23 (5.84 mm), 6 mm, 24 (6.1 mm), 25 (6.35 mm), 26 (6.60 mm), 27 (6.86 mm), 7 mm, 28 (7.11 mm), 29 (7.37 mm), 30 (7.62 mm), 31 (7.87 mm), 32 (8.13 mm), 33 (8.38 mm), 34 (8.64 mm), 35 (8.89 mm), 36 (9.14 mm), 37 (9.4 mm), 38 (9.65 mm), 39 (9.91 mm), 40 (10.16 mm), 41 (10.41 mm), 42 (10.67 mm), 43 (10.92 mm), 44 (11.18 mm), 45 (11.43 mm), 46 (11.68 mm), 47 (11.94 mm), 48 (12.19 mm), 49 (12.45 mm), and 50 (12.7 mm) caliber. Examples of such gauges (with corresponding diameter in millimeters) include 28 (13.95 mm), 24 (14.68 mm), 20 (15.67 mm), 16 (16.84 mm), 14 (17.60 mm), 13 (18.06 mm), 12 (18.52 mm), 10 (19.74 mm), and 8 (21.26 mm) gauge as well as “410 guage” that corresponds to 41 caliber (10.41 mm). The rotatable bore-members can also be configured to fit with larger barrels such as those found in artillery pieces and naval guns. Examples of such artillery pieces and naval guns include, but are not limited to, those having barrels with an inner diameter of 101 mm, 120 mm, 155 mm and 203 mm.

### Kits

The invention provides kits. In one example, such a kit can include a firearm-cleaning rod, a rotating adapter, and packaging material. In another example, a kit can include a rotating rod and packaging material. In another example, a kit can include a firearm-cleaning rod, a rotating adapter, one or more firearm-cleaning members, and packaging material. In another example, a kit can include a rotatable adapter and one or more firearm-cleaning members.

The invention provides a rotatable adapter for use in cleaning a firearm barrel that includes a first member having a rod coupling for detachable connection to a firearm-cleaning rod; and a second member having a cleaning-member coupling for detachable connection to a firearm-cleaning member where the first member and the second member are rotatably attached to one another and configured to fit within the barrel of a firearm. In some embodiments, the rod coupling is threaded. In some embodiments, the rod coupling is an external coupling. In some embodiments, the cleaning-member coupling is an internal coupling. In some embodiments, the firearm-cleaning member is a loop. In some embodiments, the firearm-cleaning member is a brush. In some embodiments, the firearm-cleaning member is a jag. In some embodiments, the firearm-cleaning member is a swab. In some embodiments, the rotatable adapter includes a third member and the first member and the second member are rotatably attached to one another by the third member. In some embodiments, the rod coupling and the cleaning-member coupling are threaded.

The invention provides a rotatable rod for cleaning a firearm barrel that includes a first member, a second member that includes a cleaning-member coupling for detachable connection to a firearm-cleaning member; and a rod having a proximal end and a distal end, where the first member is attached to the distal end of the rod, the second member is rotatably attached to the first member, the rotatable rod is configured to fit within the barrel of a firearm, and the rod does not include a continuous lumen between the proximal end and the first member. In some embodiments, the cleaning-member coupling is threaded. In some embodiments, the cleaning-member coupling is an internal coupling. In some embodiments, the rotatable rod includes a third member and the first member and the second member are rotatably attached to each other by the third member. In some embodiments, the cleaning-member coupling is threaded. In some embodiments, the rotatable rod includes a handle that is attached to the proximal end of the rod. In some embodiments, the firearm-cleaning member is a brush. In some embodiments, the firearm-cleaning member is a loop. In some embodiments, the firearm-cleaning member is a jag. In some embodiments, the firearm-cleaning member is a swab.

The invention provides a rotatable bore-member for cleaning a firearm barrel that includes a first member having a rod coupling that is configured for detachable connection to a firearm-cleaning rod and a second member that is a firearm-cleaning member for cleaning the barrel of a firearm, where the first member and the second member are rotatably attached to each other and configured to fit within the barrel of a firearm. In some embodiments, the rod coupling is threaded. In some embodiments, the rod coupling is an external coupling. In some embodiments, the firearm-cleaning member is a jag. In some embodiments, the firearm-cleaning member is a loop. In some embodiments, the firearm-cleaning member is a brush. In some embodiments, the firearm-cleaning member is a swab. In some embodiments, the rotatable bore-member further includes a third member and the first member and the second member are rotatably attached to each other by the third member.

The invention provides a kit that includes a cleaning rod, and a rotatable adapter. In some embodiments, the kit includes a firearm-cleaning member. In some embodiments, the kit includes a firearm-cleaning fluid.

The invention provides a kit that includes a rotatable rod and a firearm-cleaning member. In some embodiments, the kit includes a firearm-cleaning fluid.

The invention provides a rotatable adapter for cleaning a firearm barrel that includes a first member having a circular cross-section transverse to an axis of rotation, a substantially smooth exterior, and a rod coupling that is configured to detachably connect to a firearm-cleaning rod; a second member having a circular cross-section transverse to an axis of rotation, a substantially smooth exterior, and a cleaning-member coupling that is configured to detachably connect to a firearm-cleaning member; where the first member and the second member are rotatably attached to one another and configured to fit within the barrel of a firearm. In some embodiments, the rotatable adapter is configured to fit within a firearm barrel having an inside diameter that is 4.32 mm (17 caliber), 6.1 mm (24 caliber), 6.35 mm (25 caliber), 6.60 mm (26 caliber), or 8.13 mm (32 caliber). In some embodiments, the rotatable adapter is configured to fit within a firearm barrel having an inside diameter that is 5.59 mm (22 caliber), 5.84 mm (23 caliber), 6.86 mm (27 caliber), 7.62 mm (30 caliber), 9.65 mm (38 caliber), 10.16 mm (40 caliber), 10.67 mm (42 caliber), 11.18 mm (44 caliber), 44.43 mm (45 caliber) or 12.7 mm (50 caliber).

The invention provides a rotatable rod for cleaning a firearm barrel that includes a first member; a second member having a circular cross-section transverse to an axis of rotation, a substantially smooth exterior, and a cleaning-member coupling that is configured to detachably connect to a firearm-cleaning member; and a rod having a proximal end and a distal end, where the first member is attached to the distal end of the rod, the second member is rotatably attached to the first member, the rotatable rod is configured to fit within the barrel of a firearm, and the rod does not include a continuous lumen in connection with the first member. In some embodiments, the rotatable rod is configured to fit within a firearm barrel having an inside diameter that is 4.32 mm (17 caliber), 6.1 mm (24 caliber), 6.35 mm (25 caliber), 6.60 mm (26 caliber), or 8.13 mm (32 caliber). In some embodiments, the rotatable rod is configured to fit within a firearm barrel having an inside diameter that is 5.59 mm (22 caliber), 5.84 mm (23 caliber), 6.86 mm (27 caliber), 7.62 mm (30 caliber), 9.65 mm (38 caliber), 10.16 mm (40 caliber), 10.69 mm (42 caliber), 11.18 mm (44 caliber), 44.43 mm (45 caliber) or 12.7 mm (50 caliber).

The invention provides a rotatable bore-member for cleaning a firearm barrel that includes a first member having a circular cross-section transverse to an axis of rotation, a substantially smooth exterior, and a rod coupling that is configured to detachably connect to a firearm-cleaning rod; and a second member that is a firearm-cleaning member adapted to clean the barrel of a firearm; where the first member and the second member are rotatably attached to one another and configured to fit within the barrel of a firearm. In some embodiments, the rotatable bore-member is configured to fit within a firearm barrel having an inside diameter that is 4.32 mm (17 caliber), 6.1 mm (24 caliber), 6.35 mm (25 caliber), 6.60 mm (26 caliber), or 8.13 mm (32 caliber). In some embodiments, the rotatable bore-member is configured to fit within a firearm barrel having an inside diameter that is 5.59 mm (22 caliber), 5.84 mm (23 caliber), 6.86 mm (27 caliber), 7.62 mm (30 caliber), 9.65 mm (38 caliber), 10.16 mm (40 caliber), 10.67 mm (42 caliber), 11.18 mm (44 caliber), 44.43 mm (45 caliber) or 12.7 mm (50 caliber). In some embodiments, the firearm-cleaning member is a swab. In some embodiments, the firearm-cleaning member is a loop. In some embodiments, the firearm-cleaning member is a brush. In some embodiments, the firearm-cleaning member is a jag.

The invention provides a rotatable adapter for cleaning a firearm barrel that includes a cleaning-rod attachment mechanism configured for detachable connection of a firearm-cleaning member to a cleaning rod; and a means for allowing rotation of the firearm-cleaning member relative to the firearm-cleaning rod. In some embodiments, the rotatable adapter is configured to fit within a firearm barrel having an inside diameter that is 4.32 mm (17 caliber), 6.1 mm (24 caliber), 6.35 mm (25 caliber), 6.60 mm (26 caliber), or 8.13 mm (32 caliber). In some embodiments, the rotatable adapter is configured to fit within a firearm barrel having an inside diameter that is 5.59 mm (22 caliber), 5.84 mm (23 caliber), 6.86 mm (27 caliber), 7.62 mm (30 caliber), 9.65 mm (38 caliber), 10.16 mm (40 caliber), 10.67 mm (42 caliber), 11.18 mm (44 caliber), 44.43 mm (45 caliber) or 12.7 mm (50 caliber). In some embodiments, the firearm-cleaning member is a swab. In some embodiments, the firearm-cleaning member is a loop. In some embodiments, the firearm-cleaning member is a brush. In some embodiments, the firearm-cleaning member is a jag. In some embodiments, the cleaning-rod attachment mechanism includes an external threaded coupling.

The invention provides a rotatable rod for cleaning a firearm barrel that includes a rod having a proximal end and a distal end; and a means for allowing free rotation of a firearm-cleaning member relative to the rod that is attached to the distal end of the rod, where the rotatable rod is configured to fit within the barrel of a firearm, and the rod does not include a continuous lumen in connection with the means for allowing rotation. In some embodiments, the rotatable rod is configured to fit within a firearm barrel having an inside diameter that is 4.32 mm (17 caliber), 6.1 mm (24 caliber), 6.35 mm (25 caliber), 6.60 mm (26 caliber), or 8.13 mm (32 caliber). In some embodiments, the rotatable rod is configured to fit within a firearm barrel having an inside diameter that is 5.59 mm (22 caliber), 5.84 mm (23 caliber), 6.86 mm (27 caliber), 7.62 mm (30 caliber), 9.65 mm (38 caliber), 10.16 mm (40 caliber), 10.67 mm (42 caliber), 11.18 mm (44 caliber), 44.43 mm (45 caliber) or 12.7 mm (50 caliber). In some embodiments, the firearm-cleaning member is a swab. In some embodiments, the firearm-cleaning member is a loop. In some embodiments, the firearm-cleaning member is a brush. In some embodiments, the firearm-cleaning member is a jag.

The invention provides a rotatable bore-member for cleaning a firearm barrel that includes a cleaning-rod attachment mechanism configured for detachable connection of a firearm-cleaning member to a cleaning rod; and a means for allowing rotation of the firearm-cleaning member relative to the firearm-cleaning rod, where the means for allowing rotation includes the firearm-cleaning member. In some embodiments, the rotatable bore-member is configured to fit within a firearm barrel having an inside diameter that is 4.32 mm (17 caliber), 6.1 mm (24 caliber), 6.35 mm (25 caliber), 6.60 mm (26 caliber), or 8.13 mm (32 caliber). In some embodiments, the rotatable bore-member is configured to fit within a firearm barrel having an inside diameter that is 5.59 mm (22 caliber), 5.84 mm (23 caliber), 6.86 mm (27 caliber), 7.62 mm (30 caliber), 9.65 mm (38 caliber), 10.16 mm (40 caliber), 10.67 mm (42 caliber), 11.18 mm (44 caliber), 44.43 mm (45 caliber) or 12.7 mm (50 caliber). In some embodiments, the firearm-cleaning member is a swab. In some embodiments, the firearm-cleaning member is a loop. In some embodiments, the firearm-cleaning member is a brush. In some embodiments, the firearm-cleaning member is a jag.

1. A rotatable bore-member for cleaning a firearm barrel comprising:
a first member having a rod coupling that is configured for detachable connection to a firearm-cleaning rod;
a second member that is a firearm-cleaning member for cleaning the barrel of a firearm; and
wherein the first member and the second member are rotatably attached to each other and configured to fit within the barrel of a firearm and the rod coupling is non-rotationally attached to the first member.

2. The rotatable bore-member according to claim 1, wherein the rod coupling is threaded.

3. The rotatable bore-member according to claim 1, wherein the rod coupling is an external coupling.

4. The rotatable bore-member according to claim 1, wherein the firearm-cleaning member is a jag.

5. The rotatable bore-member according to claim 1 further comprising a third member and the first member and the second member are rotatably attached to each other by the third member.

6. The rotatable bore-member according to claim 1, wherein the rotatable bore-member is included within a kit.

7. The rotatable bore-member according to claim 6, wherein the kit includes a firearm-cleaning rod.

8. A rotatable bore-member for cleaning a firearm barrel comprising:
a first member having a circular cross-section transverse to an axis of rotation, a substantially smooth exterior, and a rod coupling that is configured to detachably connect to a firearm-cleaning rod; and
a second member that is a firearm-cleaning member adapted to clean the barrel of a firearm;
wherein the first member and the second member are rotatably attached to one another and configured to fit within the barrel of a firearm and the rod coupling is non-rotationally attached to the first member.

9. The rotatable bore-member according to claim 8, wherein the rotatable bore-member is configured to fit within a firearm barrel that is a caliber selected from the group consisting of a 17, 24, 25, 26, and 32 caliber.

10. The rotatable bore-member according to claim 8, wherein the firearm-cleaning member is a swab.

11. The rotatable bore-member according to claim 8, wherein the rotatable bore-member is included within a kit.

12. The rotatable bore-member according to claim 11, wherein the kit includes a firearm-cleaning rod.

13. A rotatable bore-member for cleaning a firearm barrel comprising:
a cleaning-rod attachment mechanism configured for detachable connection of a firearm-cleaning member to a cleaning rod through a rod coupling; and
means for allowing rotation of the firearm-cleaning member relative to the firearm-cleaning rod,
wherein the means for allowing rotation includes the firearm-cleaning member and the rod coupling is non-rotationally attached to the cleaning-rod attachment mechanism.

14. The rotatable bore-member according to claim 13, wherein the rotatable member is configured to fit within a firearm barrel that is a caliber selected from the group consisting of a 17, 24, 25, 26, and 32 caliber.

15. The rotatable bore-member according to claim 13, wherein the firearm-cleaning member is a loop.

16. The rotatable bore-member according to claim 13, wherein the rotatable bore-member is included within a kit.

17. The rotatable bore-member according to claim 16, wherein the kit includes a firearm-cleaning rod.

18. The rotatable bore-member according to claim 1, wherein the firearm-cleaning member is a loop.

19. The rotatable bore-member according to claim 1, wherein the firearm-cleaning member is a brush.

20. The rotatable bore-member according to claim 1, wherein the firearm-cleaning member is a swab.
